(19) United States
(12) Patent Application Publication
(10) Pub. No.: US 2013/0149632 A1
(43) Pub. Date: Jun. 13, 2013

(54) ELECTRODE CATALYST FOR A FUEL CELL, METHOD OF PREPARING THE SAME, AND MEMBRANE ELECTRODE ASSEMBLY AND FUEL CELL INCLUDING THE ELECTRODE CATALYST

(71) Applicants: SAMSUNG ELECTRONICS CO., LTD., Suwon-si (KR); SAMSUNG SDI CO., LTD., Yongin-si (KR)

(72) Inventors: Dae-jong YOO, Seoul (KR); Chan-ho PAK, Seoul (KR); Seon-ah JIN, Pocheon-si (KR); Kang-hee LEE, Suwon-si (KR)

(73) Assignees: SAMSUNG SDI CO., LTD., Yongin-si (KR); SAMSUNG ELECTRONICS CO., LTD., Suwon-si (KR)

(21) Appl. No.: 13/710,173

(22) Filed: Dec. 10, 2012

(30) Foreign Application Priority Data
Dec. 12, 2011 (KR) 10-2011-0133048
Dec. 7, 2012 (KR) 10-2012-0142322

(51) Int. Cl. H01M 4/86; H01M 8/10; H01M 4/92

(52) U.S. Cl. CPC H01M 4/8621; H01M 4/926; H01M 4/92; H01M 8/10
USPC 429/487; 429/532; 429/524; 429/525; 429/526; 429/527; 429/528; 502/101

(57) ABSTRACT

An electrode catalyst for a fuel cell including porous catalyst particles including a noble metal having oxygen-reduction activity and a carbonaceous support, wherein the porous catalyst particles are disposed on the carbonaceous support, and an electrochemical specific surface area of the porous catalyst particles is about 70 m²/g or more.

This application claims the benefit of and priority to Korean Patent Application No. 10-2011-0133048, filed on Dec. 12, 2011, and Korean Patent Application No. 10-2012-0142322, filed on Dec. 7, 2012, and all the benefits accruing therefrom under 35 U.S.C. §119, the contents of which are incorporated herein in their entirety by reference.

### BACKGROUND

1. Field

The present disclosure relates to an electrode catalyst for a fuel cell, a method of preparing the same, a membrane electrode assembly including the same, and a fuel cell including the membrane electrode assembly.

2. Description of the Related Art

A fuel cell is a power-generating device which directly transforms the chemical energy of hydrogen and oxygen into electrical energy. An efficiency of a fuel cell is about twice that of an internal combustion engine and electricity may be continuously produced as long as hydrogen and oxygen are supplied.

Fuel cells may be classified as a polymer electrolyte membrane fuel cell (PEMFC), a direct methanol fuel cell (DMFC), a phosphoric acid fuel cell (PAFC), a molten carbonate fuel cell (MCFC), or a solid oxide fuel cell (SOFC) according to a type of electrolyte and fuel used.

The PEMFC and DMFC generally include a membrane electrode assembly (MEA) including an anode, a cathode, and a polymer electrolyte membrane disposed between the anode and the cathode. A catalyst layer for promoting oxidation of a fuel is included in the anode of the fuel cell and a catalyst layer for promoting reduction of an oxidant is included in the cathode.

In general, a catalyst having platinum (Pt) as an active component is used in the cathode and the anode. However, the platinum-based catalyst is expensive and thus there is a need for cost reduction because the platinum cost of the electrode catalyst is still a barrier to mass production of commercially viable fuel cells.

Therefore, there remains a need for development of an electrode catalyst, which may provide excellent cell performance as well as a decrease in the amount of platinum included therein.

### SUMMARY

Provided is an electrode catalyst for a fuel cell which provides excellent catalyst activity and a method of preparing the same.

Provided is a membrane electrode assembly and a fuel cell including the electrode catalyst.

Additional aspects will be set forth in part in the description which follows and, in part, will be apparent from the description.

According to an aspect, an electrode catalyst for a fuel cell includes: porous catalyst particles including a noble metal having oxygen-reduction activity; and a carbonaceous support, wherein the porous catalyst particles are disposed on the carbonaceous support, and an electrochemical specific surface area of the porous catalyst particles is about 70 m²/g or more.

The porous catalyst particles may include pores and a skeleton including the noble metal.

The noble metal may include one or more selected from palladium (Pd), iridium (Ir), gold (Au), platinum (Pt), rhenium (Re), osmium (Os), ruthenium (Ru), rhodium (Rh), and silver (Ag).

The porous catalyst particles may include a composition represented by Formula 1:

Pd_{1-y}Ir_{y} Formula 1

wherein y denotes an atomic ratio of Ir to Pd and 0<y<1.

The porous catalyst particles may further include a transition metal including one or more selected from titanium (Ti), vanadium (V), chromium (Cr), manganese (Mn), iron (Fe), cobalt (Co), nickel (Ni), copper (Cu), and zinc (Zn).

The porous catalyst particles may further include a metal oxide.

The metal oxide may include one or more selected from manganese oxide, iron oxide, cobalt oxide, nickel oxide, and zinc oxide.

A content of the metal oxide may be about 0.6 parts by weight or less, based on 100 parts by weight of the electrode catalyst.

The carbonaceous support may include an ordered mesoporous carbon having mesopores.

Also disclosed is a porous catalyst particle including: a noble metal having oxygen-reduction activity, wherein the electrochemical specific surface area of the porous catalyst particles is about 80 m²/g to about 100 m²/g, and the noble metal defines pores having an average diameter of about 0.01 nanometer to about 1 nanometer.

According to another aspect, a method of preparing an electrode catalyst for a fuel cell includes: providing a pre-catalyst including a carbonaceous support, and pre-particles disposed on the carbonaceous support, the pre-particles including a noble metal having oxygen-reduction activity, and a metal oxide; and removing the metal oxide from the pre-particles to prepare the electrode catalyst.

The metal oxide may include one or more selected from manganese oxide, iron oxide, cobalt oxide, nickel oxide, and zinc oxide.

Pores of the porous catalyst particles may correspond to regions of the metal oxide in the pre-particles.

The preparing of the pre-catalyst may include providing a metal precursor mixture, wherein the metal precursor mixture may include a noble metal precursor including a noble metal having oxygen-reduction activity and a metal oxide precursor.

The removing of the metal oxide from the pre-particles may include contacting the pre-catalyst with an acid.

The acid may include one or more selected from HNO₃, HClO₃, HBrO₃, HCl, H₂SO₄, H₃PO₄, and CH₃COOH.

According to another aspect, a membrane electrode assembly for a fuel cell includes: a cathode; an anode disposed facing to the cathode; and an electrolyte membrane disposed between the cathode and the anode, wherein one or more of the cathode and the anode includes the electrode catalyst.

In an aspect, the catalyst may be included in the cathode of the membrane electrode assembly.

According to another aspect, a fuel cell includes the membrane electrode assembly.

In an aspect, the catalyst may be included in the cathode of the membrane electrode assembly of the fuel cell.

### BRIEF DESCRIPTION OF THE DRAWINGS

FIG. 1 is a schematic diagram illustrating an embodiment of the catalyst;

FIG. 2 is a schematic diagram illustrating an embodiment of a method of preparing the catalyst;

FIG. 3 is an exploded perspective view illustrating an embodiment of the fuel cell;

FIG. 4 is a schematic cross-sectional view illustrating an embodiment of a membrane electrode assembly (MEA) of the fuel cell of FIG. 3;

FIG. 5 is a transmission electron micrograph (TEM) of Catalyst 2 of Example 2;

FIG. 6 is a graph of relative intensity (arbitrary units, a.u.) versus scattering angle (degrees two-theta, 28) illustrating the results of X-ray diffraction (XRD) analysis on Catalyst A of Comparative Example A, Pre-catalyst 2 of Example 2, Catalyst 2 of Example 2, Pre-catalyst 5 of Example 5, and Catalyst 5 of Example 5;

FIG. 7 is a graph of mass activity (amperes per grams catalyst, A/g_{catalyst}) versus potential (volts versus normal hydrogen electrode, V vs. NHE) illustrating hydrogen adsorption amounts of Catalyst A of Comparative Example A, Catalyst 1 of Example 1, Catalyst 2 of Example 2, and Catalyst 5 of Example 5 in terms of mass activities;

FIG. 8 is a graph of mass activity (amperes per grams catalyst, A/g_{catalyst}) versus potential (volts versus normal hydrogen electrode, V vs. NHE) illustrating oxygen reduction reaction (ORR) characteristics of Catalyst A of Comparative Example A, Catalyst 1 of Example 1, Catalyst 2 of Example 2 and Catalyst 5 of Example 5 in terms of mass activities; and

FIG. 9 is a graph of cell voltage (volts, V) versus current density (milliamperes per square centimeter, mA/cm²) for the unit cells using Catalyst A of Comparative Example A Catalyst 2 of Example 2, and Catalyst 5 of Example 5, respectively.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Carbonaceous means comprising carbon.

An electrode catalyst for a fuel cell includes porous catalyst particles including a noble metal having oxygen-reduction activity, and a carbonaceous support. The porous catalyst particles are disposed on (e.g., impregnated in) the carbonaceous support.

The noble metal in the porous catalyst particles may comprise a single metal or two or more different metals. When the catalyst particles include two or more different metals, the noble metal may be present as an alloy, a mixture, or as an intermetallic compound.

The catalyst particles are particles that may be uniformly dispersed on the support in order to decrease a size of the catalyst particles (e.g., the catalyst particles may have an average particle diameter of a few to few tens of nanometers (nm), specifically 1 to 50 nm, more specifically 3 to 30 nm) and the support may effectively prevent agglomeration of the catalyst particles. Also, the catalyst particles may be distinguished from a layer or film comprising the noble metal. The porous catalyst particles including a noble metal have a very large specific surface area that may be in contact with various gases and/or liquids, which are targets of electrochemical reactions, in comparison to the layer or film formed of the noble metal, and thus, may be usefully used as a catalyst, for example, as an electrode catalyst for a fuel cell.

The catalyst particles are porous. That is, the catalyst particles may have a plurality of pores. For example, the catalyst particles may include a skeleton having a skeletal or fractal-like structure having walls which define the pores. The skeleton may be a matrix which comprises the noble metal. The pores may be connected to one another to form channels. Since the pores and the skeleton are formed by removing a metal oxide from pre-particles (as will be further described below), a shape of the pores and the skeleton may be any shape, and may be spherical, tubular, conical, or a combination thereof, and thus may appear not have any particular form, and may have a shape defined by the metal oxide. The pores of the porous catalyst particles may be defined by the noble metal and the carbonaceous support. Also, the porous catalyst particles may comprise a pore defined entirely by the noble metal. Since the pores are formed by removing the metal oxide which is combined with the noble metal from the pre-particles, which will be further described below, the pores may also have a size, e.g., a minimum size, which is defined by the metal oxide. For example, an average diameter of the pores (e.g., an average largest diameter) may be about 0.01 nanometer (nm) to about 1 nm, specifically about 0.05 nm to about 0.8 nm, for example, about 0.1 nm to about 0.5 nm, and an average thickness of the skeleton, e.g., a thickness of a wall of the catalyst particles, may be about 0.5 nm to about 3 nm, specifically about 0.7 nm to about 2.5 nm, more specifically about 0.9 nm to about 2 nm, but the average diameter of the pores and the average thickness of the skeleton are not limited thereto.

Since the electrode catalyst includes the foregoing porous catalyst particles, the electrode catalyst may have a very large electrochemical specific surface area. Therefore, a fuel cell using the electrode catalyst may have excellent electrochemical activity, and thus, a fuel cell having improved performance may be prepared.

An electrochemical specific surface area of the porous catalyst particles may be about 70 square meters per gram (m²/g) or more, specifically about 70 m²/g to about 500 m²/g, more specifically about 70 m²/g to about 100 m²/g. According to an embodiment, the electrochemical specific surface area of the porous catalyst particles may be about 80 m²/g to about 100 m²/g or about 85 m²/g to about 96 m²/g, but the electrochemical specific surface area of the porous catalyst particles is not limited thereto. Since the porous catalyst particles in the electrode catalyst include the plurality of pores generated by removing the metal oxide from the pre-particles, which will be further described below, the porous catalyst particles may have an electrochemical specific surface area within the foregoing range. The electrochemical specific surface area of the porous catalyst particles may be obtained by dividing a hydrogen desorption charge (Q_{H}) of the porous catalyst particles by 0.21 millicoulombs per square centimeter (mC/cm²) and a weight of the porous catalyst particles. Herein, 0.21 mC/cm² is an intrinsic constant with respect to a quantity of electric charge when hydrogen is adsorbed as a single molecular layer on a catalyst particle.

The noble metal may be a metal having oxygen-reduction activity. The noble metal may include one or more selected from palladium (Pd), iridium (Ir), gold (Au), platinum (Pt), rhenium (Re), osmium (Os), ruthenium (Ru), rhodium (Rh), and silver (Ag), but the noble metal is not limited thereto. For example, the noble metal may include palladium. According to an embodiment, the noble metal may include palladium and iridium. While not wanting to be bound by theory, it is understood that the iridium may promote durability of the porous catalyst particles, and thus the iridium may contribute to improving the stability of the electrode catalyst.

For example, the porous catalyst particles may comprise a composition represented by Formula 1:

Pd_{1-y}Ir_{y} Formula 1

wherein y denotes an atomic ratio of Ir to Pd and 0<y<1.

For example, y in Chemical Formula 1 may be 0.4≦y≦0.9, and may be about 0.5, but y is not limited thereto.

The porous catalyst particles may further include a transition metal including one or more selected from titanium (Ti), vanadium (V), chromium (Cr), manganese (Mn), iron (Fe), cobalt (Co), nickel (Ni), copper (Cu), and zinc (Zn). For example, the porous catalyst particles may further include cobalt and copper, but the porous catalyst particles are not limited thereto.

The porous catalyst particles may further include a metal oxide. The metal oxide may be an oxide of a metal of Groups 7 to 12 of the periodic table of the elements, which has sufficient acid solubility so that it can be substantially or entirely removed by treatment with an acid. The metal oxide may include one or more selected from manganese oxide, iron oxide, cobalt oxide, nickel oxide, and zinc oxide. For example, the metal oxide may be manganese oxide (e.g., MnOₓ wherein x is 0<x≦2) or zinc oxide (e.g., ZnOₓ, wherein x is 0<x≦2), but the metal oxide is not limited thereto.

The metal oxide may be included in the pre-particles which will be further described below, and a portion of the metal oxide, or a compound derived from the metal oxide, may not be removed, and thus a portion of the metal oxide, or a compound derived from the metal oxide, may be present in the catalyst particles. Therefore, the porous catalyst particles may not include the metal oxide or may include the metal oxide. For example, a content of the metal oxide may be about 0.6 part by weight or less, based on 100 parts by weight of the electrode catalyst, or may be about 0.5 part by weight or less, based on 100 parts by weight of the electrode catalyst. For example, the content of the metal oxide may be about 0.1 part by weight to about 0.5 part by weight, based on 100 parts by weight of the electrode catalyst, but the content of the metal oxide is not limited thereto.

The compound derived from the metal oxide may be a product of the process of removing the metal oxide. For example, the compound derived from the metal oxide may be product of heating the metal oxide in an inert or reducing atmosphere, such as an atmosphere comprising argon or hydrogen, respectively, and then treating with an acid, such as one or more selected from HNO₃, HClO₃, HBrO₃, HCl, H₂SO₄, H₃PO₄, and CH₃COOH.

An average particle diameter of the porous catalyst particles may be about 1 nm to about 10 nm, for example, about 2 nm to about 5 nm. When the average particle diameter of the porous catalyst particles satisfies the foregoing range, excellent oxygen-reduction activity and electrochemical specific surface area may be maintained.

The electrode catalyst further includes a carbonaceous support. The porous catalyst particles are disposed on the carbonaceous support, and the carbonaceous support may be impregnated with the porous catalyst particles. The porous catalyst particles are dispersed from one another without substantial agglomeration and may be impregnated in the carbonaceous support.

The carbonaceous support may be a carbon containing electrically conductive material. The carbonaceous support may comprise any type of carbon that suitably supports the catalyst particles. The carbonaceous support may comprise an amorphous carbon, a crystalline or graphitic carbon, or a vitreous or glassy carbon. Also, the carbonaceous support may be in any suitable form, and may be in the form of a powder, fiber, or flake, and may have any suitable crystallographic orientation, crystallite size, interlayer spacing, density, particle size, or particle shape. For example, the carbonaceous support may comprise one or more selected from Ketjen black, carbon black, lamp black, acetylene black, mesocarbon, graphitic carbon, pyrolytic graphite, single-wall carbon nanotubes, multi-wall carbon nanotubes, and carbon fibers. The carbonaceous support is not limited to the foregoing and the foregoing electrically conductive materials may be used alone or may be used in a combination thereof.

A content of the porous catalyst particles may be about 30 parts by weight to about 70 parts by weight, based on 100 parts by weight of the electrode catalyst, and for example, may be about 40 parts by weight to about 60 parts by weight, or about 45 parts by weight to about 55 parts, based on 100 parts by weight of the electrode catalyst. When a content of the porous catalyst particles satisfies the foregoing range, excellent specific surface area and a desirably high loading of the porous catalyst particles may be obtained.

The carbonaceous support may include an ordered mesoporous carbon having mesopores. An average diameter of the mesopores may be about 2 nm to about 50 nm, specifically about 4 nm to about 40 nm, more specifically about 6 nm to 10 nm. The ordered mesoporous carbon having mesopores may be prepared using a mesoporous silica mold (e.g., mesostructured hexagonal silica, MSU-H). Since the ordered mesoporous carbon has a large specific surface area, a greater content of porous catalyst particles may be disposed on (e.g., impregnated in) the carbonaceous support, with respect to a weight of the carbonaceous support, when the ordered mesoporous carbon is used as the carbonaceous support.

An electrochemical specific surface area of the electrode catalyst may be about 10 square meters per gram (m²/g) or more, specifically about 70 m²/g to about 500 m²/g, more specifically about 70 m²/g to about 100 m²/g. According to an embodiment, the electrochemical specific surface area of the electrode catalyst may be about 80 m²/g to about 100 m²/g or about 85 m²/g to about 96 m²/g.

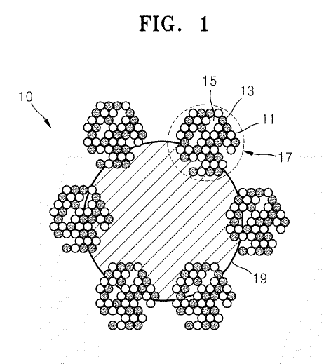

FIG. 1 is a schematic drawing illustrating an embodiment of an electrode catalyst 10. The electrode catalyst 10 of FIG. 1 includes a plurality of porous catalyst particles 17 and a carbonaceous support 19. The porous catalyst particles 17 are disposed on (e.g., dispersed and impregnated in) the carbonaceous support 19. The porous catalyst particles 17 include a first noble metal (e.g., palladium) 11, a second noble metal (e.g., iridium) 13, and a plurality of pores 15 defined by the first noble metal and the second noble metal (if present). The pores 15 may also be defined by the carbonaceous support 19. In an embodiment, the porous catalyst particles 17 comprise an alloy of the first noble metal and the second noble metal. The porous catalyst particles 17 comprise the plurality of pores 15. The first noble metal, and if present the second noble metal, may form a skeletal structure that can be a matrix, which is a region excluding the pores 15 in the porous catalyst particles 17. The porous catalyst particles 17 of the electrode catalyst 10 include the plurality of pores 15 and are also disposed on (e.g., are dispersed in) the carbonaceous support. Therefore, the porous catalyst particles 17 may have a very large electrochemical specific surface area.

The porous catalyst particles 17 of the electrode catalyst 10 may have a hydrogen desorption charge (Q_{H}) of about 1×10⁻³ millicoulombs per square centimeter (mC/cm²) to about 100×10⁻³ mC/cm², specifically about 40×10⁻³ mC/cm² to about 80×10⁻³ mC/cm², more specifically about 50×10⁻³ mC/cm² to about 70×10⁻³ mC/cm².

A method of preparing the electrode catalyst for a fuel cell may include preparing a pre-catalyst including pre-particles including a noble metal having oxygen-reduction activity and metal oxide, and a carbonaceous support, in which the carbonaceous support is impregnated with the pre-particles, and preparing the electrode catalyst from the pre-catalyst by removing the metal oxide from the pre-particles.

The pre-particles include the metal oxide in addition to the foregoing noble metal. For example, the pre-particles may be an alloy or a composite of the noble metal and the metal oxide.

The metal oxide may be combined (e.g., alloyed) with the noble metal included in the pre-particles and removed, and thus, the metal oxide is a sacrificial material contributing to the formation of pores in porous catalyst particles. The metal oxide may be relatively easily removed by an etchant, for example, an acid. Therefore, the metal oxide may be one or more selected from oxides that may be dissolved by an acid, or the like. As is further described above, the metal oxide may include one or more selected from manganese oxide, iron oxide, cobalt oxide, nickel oxide, and zinc oxide. For example, the metal oxide may be a manganese oxide or a zinc oxide, but the metal oxide is not limited thereto.

A content of the metal oxide in the pre-particles may be such that a metal content of the metal oxide is about 10 parts by weight to about 300 parts by weight, based on 100 parts by weight of a content of the noble metal included in the pre-particles, for example, about 50 parts by weight to about 200 parts by weight, based on 100 parts by weight of a content of the noble metal included in the pre-particles. When the content of the metal oxide in the pre-particles satisfies the foregoing range, pores may be formed in an amount that is suitable to improve the electrochemical specific surface area of the porous catalyst particles and a sufficient content of the noble metal may remain in the porous catalyst particles generated by removal of the metal oxide.

The pre-catalyst includes the carbonaceous support, and the carbonaceous support may be impregnated with the pre-particles. A detailed description of the carbonaceous support is provided above.

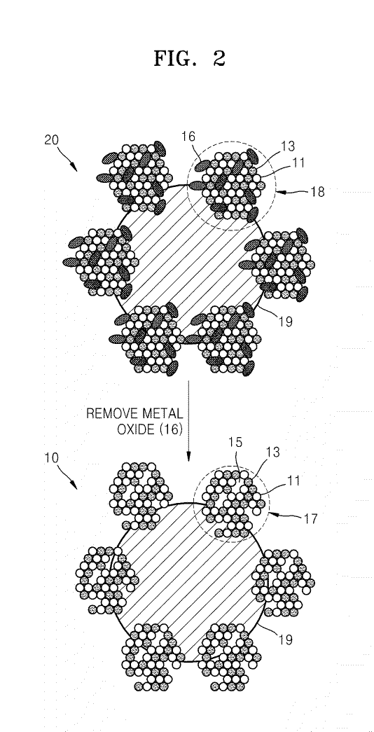

FIG. 2 is a schematic illustration of an embodiment of a method of preparing an electrode catalyst.

First, a pre-catalyst 20, including a carbonaceous support 19 and a plurality of pre-particles 18, is prepared. The pre-particles 18 are disposed on (e.g., dispersed and impregnated in) the carbonaceous support 19. The pre-particles 18 include the first noble metal 11 (e.g., palladium), optionally the second noble metal 13 (e.g., iridium), and a metal oxide 16. The metal oxide 16 may comprise a single metal oxide or may be an agglomerate or a combination of a plurality of metal oxides. The pre-particles 18 may comprise an alloy of, or may be a combination of, the first noble metal, if present the second noble metal, and the metal oxide 16.

The metal oxide 16 is partially or entirely removed from the pre-particles 18 of the pre-catalyst 20 to prepare an electrode catalyst 10, which includes the porous catalyst particles 17 and the carbonaceous support 19. The electrode catalyst 10 is further described above with reference to FIG. 1. As is noted above, the metal oxide 16 in the pre-particles 18 may not be completely removed. Therefore, the porous catalyst particles 17 may include a small amount of the metal oxide 16, or a compound derived from the metal oxide 16. A content of the metal oxide 16 of the porous catalyst particles 17 is provided above.

Regions occupied by the metal oxide 16 in the pre-particles 18 of the pre-catalyst 20 correspond to pores 15 in the catalyst particles 17 of the electrode catalyst 10.

According to the preparation method, after the preparation of the pre-catalyst 20, pores may be formed in the porous catalyst particles 17 by a commercially attractive process (e.g., an acid treatment process which will be further described below) that removes all or a portion of the metal oxide, and thus, the porous catalyst particles 17 may be prepared which avoids use of a complicated or expensive process (e.g., use of a mold or a template) to form the pores. Therefore, an electrode catalyst having a large electrochemical specific surface area may be easily prepared at a low cost when the foregoing preparation method is used.

The preparing of the pre-catalyst 20 may include providing a metal precursor mixture. The metal precursor mixture may include a noble metal precursor comprising a noble metal which has oxygen-reduction activity and a metal oxide precursor. When two or more different noble metals are used in the pre-particles 18 of the pre-catalyst 20, the noble metal precursor may comprise two or more different noble metals.

The noble metal precursor may include one or more selected from a chloride, nitride, cyanide, sulfide, bromide, nitrate, acetate, sulfide, oxide, hydroxide, and alkoxide which include the noble metal, and a derivative thereof.

When the noble metal includes palladium, examples of a palladium precursor include one or more compounds selected from palladium nitride, palladium chloride, palladium sulfide, palladium acetate, palladium acetylacetonate, palladium cyanide, palladium isopropyl oxide, palladium butoxide, and K₂PdCl₄, but the palladium precursor is not limited thereto.

When the noble metal includes iridium, examples of an iridium precursor include one or more compounds selected from iridium nitride, iridium chloride, iridium sulfide, iridium acetate, iridium acetylacetonate, iridium cyanide, iridium isopropyl oxide, iridium butoxide, and H₂IrCl₆.6H₂O, but the iridium precursor is not limited thereto.

The metal oxide precursor may include one or more compounds selected from an oxide, chloride, nitride, cyanide, sulfide, bromide, nitrate, acetate, sulfide, hydroxide, and an alkoxide which include a metal of the foregoing metal oxides, and a derivative thereof.

When the metal oxide includes manganese oxide, examples of the metal oxide precursor include one or more compounds selected from manganese nitride, manganese chloride, manganese sulfide, manganese acetate, manganese acetylacetonate, manganese cyanide, manganese isopropyl oxide, manganese butoxide, and KMnO₄, but the metal oxide precursor is not limited thereto.

The pre-catalyst further includes a carbonaceous support, and the preparing of the pre-catalyst may further include providing a carbonaceous support mixture. The carbonaceous support mixture may comprise the carbonaceous support, a solvent, and optionally water. The solvent may be a polar organic liquid, such as an organic compound that includes a hydroxyl group. Examples of the solvent include a glycol-based solvent, such as ethylene glycol, 1,2-propylene glycol, 1,3-butanediol, 1,4-butanediol, neopentyl glycol, diethylene glycol, 3-methyl-1,5-pentanediol, 1,6-hexanediol, isopropyl alcohol (IPA), and butanol. However, the solvent is not limited thereto, and any known solvent may be used.

A mixture for forming a pre-catalyst is prepared using the metal precursor mixture and the carbonaceous support mixture. In addition to the noble metal precursor and the metal oxide precursor, the mixture for forming a pre-catalyst may further include a solvent that may dissolve these precursors. The solvent may be a polar organic liquid, such as an organic compound that includes a hydroxyl group. Examples of the solvent include a glycol-based solvent, such as ethylene glycol, 1,2-propylene glycol, 1,3-butanediol, 1,4-butanediol, neopentyl glycol, diethylene glycol, 3-methyl-1,5-pentanediol, 1,6-hexanediol, and trimethylolpropane; or an alcohol-based solvent such as methanol, ethanol, isopropyl alcohol (IPA), and butanol. However, the solvent is not limited thereto, and any known solvent may be used so long as the solvent may dissolve the precursors.

A content of the solvent may be about 15,000 parts by weight to about 100,000 parts by weight, specifically about 20,000 parts by weight to about 80,000 parts by weight, based on a total weight of the noble metal precursor and the metal oxide precursor. When the content of the solvent satisfies the foregoing range, uniform pre-catalyst particles may be formed by reduction of the precursors included in the mixture for forming the pre-catalyst. Further, including the carbonaceous support in the mixture for forming the pre-catalyst improves dispersibility of the pre-particles in the carbonaceous support.

In another embodiment, the carbonaceous support may be omitted to provide a mixture for forming the pre-particles. The mixture for forming the pre-particles which omits the carbonaceous support includes the noble metal precursor, the metal oxide precursor, and optionally the solvent. The mixture for forming the pre-particles may otherwise be the same as the mixture for forming the pre-catalyst.

The mixture for forming a pre-catalyst may further include a chelating agent (e.g., an ethylenediaminetetraacetic acid (EDTA), or a sodium citrate aqueous solution) to facilitate reducing the noble metal precursor and the metal oxide precursor at the same time, and a pH adjuster (e.g., aqueous NaOH), and the like.

Subsequently, a pre-catalyst including the foregoing pre-particles is prepared by reducing the noble metal precursor and the metal oxide precursor in the mixture for forming a pre-catalyst.

The reducing of the precursors in the mixture for forming a pre-catalyst may be performed by adding a reducing agent to the mixture.

The reducing agent may be a reducing agent that reduces the precursors included in the mixture for forming a pre-catalyst. Examples of the reducing agent include one or more selected from hydrazine (NH₂NH₂), sodium borohydride (NaBH₄), and a formic acid, but the reducing agent is not limited thereto. A content of the reducing agent may be about 0.1 mol to about 5 mols, specifically about 1 mol to about 3 mols, based on 1 mol of a sum of the noble metal precursor and the metal oxide precursor. When the content of the reducing agent satisfies the foregoing range, a satisfactory reduction reaction may be induced.

The reduction reaction of the precursors in the mixture for forming a catalyst may depend on the type and content of the precursors, and for example, may be performed at a temperature of about 70° C. to about 200° C., for example, about 90° C. to about 160° C., for specifically about 0.5 hour to about 10 hours, specifically about 1 hour to about 3 hours. However, the reduction reaction of the precursors is not limited thereto.

The pre-catalyst is formed as described above and the metal oxide in the pre-particles of the pre-catalyst is then removed by an acid treatment of the pre-catalyst to form the electrode catalyst, which includes the porous catalyst particles.

The acid may be any acid which may dissolve the metal oxide of the pre-particles and also not undesirably affect or react with the noble metal of the pre-particles to provide a catalyst having suitable properties. For example, the acid may include one or more selected from HNO₃, HClO₃, HBrO₃, HCl, H₂SO₄, H₃PO₄, and CH₃COOH, but the acid is not limited thereto.

Before performing the acid treatment, the pre-catalyst may be heat treated (e.g., heat treating at a temperature of about 100° C. to about 500° C., specifically about 200° C. to about 400° C., for about 0.1 hour to about 10 hours, specifically about 1 hour to about 5 hours) in an inert atmosphere (e.g., an atmosphere comprising hydrogen, helium, nitrogen, argon, or a combination thereof, such as a hydrogen atmosphere) or a reducing atmosphere (e.g., an atmosphere comprising hydrogen) and cooled (e.g., cooling to room temperature), and then the acid treatment may be performed.

An increase in an electrochemical specific surface area of the electrode catalyst may be represented by a change in the hydrogen desorption charge (ΔQ_{H}) according to Equation 1

ΔQ_{H}(%)=Q_{H}(porous)/Q_{H}(non-porous)×100 Equation 1:

wherein Q_{H} (porous) denotes a hydrogen desorption charge of the catalyst and Q_{H} (non-porous) denotes a hydrogen desorption charge of a catalyst including non-porous catalyst particles including the same noble metal as that included in the porous catalyst particles of the electrode catalyst.

ΔQ_{H} of the electrode catalyst may be greater than about 100% and equal to or less than about 500%, and for example, may be about 150% to about 250%. However, ΔQ_{H} of the electrode catalyst is not limited thereto.

A membrane electrode assembly according to another aspect includes a cathode and an anode disposed facing each other, and an electrolyte membrane disposed between the cathode and the anode, in which at least one of the cathode and the anode includes the electrode catalyst. For example, the cathode of the membrane electrode assembly may include the electrode catalyst.

A fuel cell according to another aspect includes the membrane electrode assembly. Bipolar plates may be stacked and included at opposite sides of the membrane electrode assembly. The membrane electrode assembly includes a cathode and an anode, and an electrolyte membrane disposed between the cathode and the anode, and at least one of the cathode and the anode includes the foregoing electrode catalyst. An embodiment in which the cathode of the fuel cell includes the electrode catalyst is specifically mentioned.

The fuel cell, for example, may be a polymer electrolyte membrane fuel cell (PEMFC), a phosphoric acid fuel cell (PAFC), or a direct methanol fuel cell (DMFC).

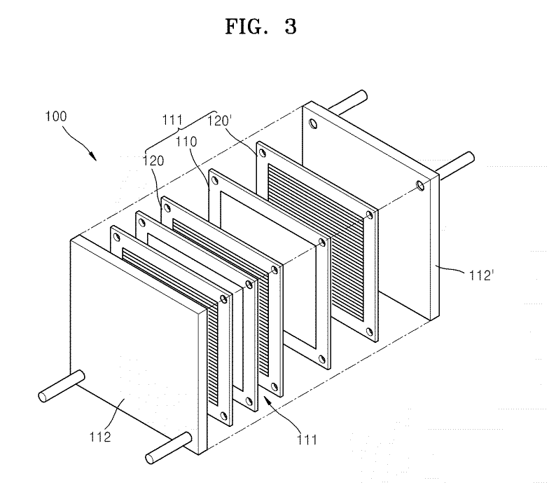

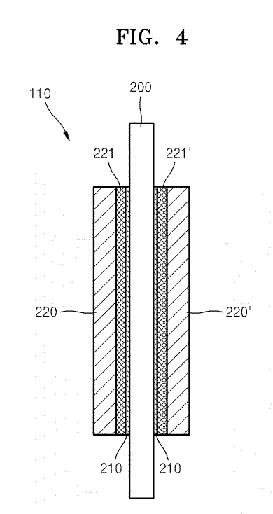

FIG. 3 is an exploded perspective view illustrating an embodiment of a fuel cell 100 and FIG. 4 is a schematic cross-sectional view illustrating a membrane electrode assembly 110 of the fuel cell 100 of FIG. 3.

The fuel cell 100 schematically shown in FIG. 3 comprises two unit cells 111 fastened between a pair of pressure plates 112. The unit cell 111 comprises the membrane electrode assembly 110 and first and second bipolar plates 120 and 120′, respectively, disposed at opposite sides of the membrane electrode assembly 110 in a thickness direction. The bipolar plates 120 and 120′ comprise a conductive material, such as a metal or carbon, and function as a current collector by contacting with the membrane electrode assembly 110, and at the same time supply oxygen and fuel to opposite sides of the membrane electrode assembly 110. In an embodiment the bipolar plates 120 are non-porous. In another embodiment the bipolar plates are porous and in operation the pores comprise water.

In the fuel cell 100 shown in FIG. 3, the number of unit cells 111 is two, but the number of unit cells is not limited to two and may be increased as desired. In an embodiment the fuel cell comprises about 2 to about 1000 unit cells 111.

As shown in FIG. 4, the membrane electrode assembly 110 may comprise an electrolyte membrane 200, and first and second catalyst layers 210 and 210′ disposed on opposite sides of the electrolyte membrane 200 in a thickness direction. One or both of the first and second catalyst layers 210 and 210′ comprise the electrode catalyst. First and second primary gas diffusion layers 221 and 221′ are disposed on the first and second catalyst layers 210 and 210′, respectively, and first and second secondary gas diffusion layers 220 and 220′ are disposed on the first gas diffusion layers 221 and 221′, respectively.

In an embodiment, the first and second secondary gas diffusion layers 220 and 220′ may be omitted.

The first and second catalyst layers 210 and 210′ function as a fuel electrode and an oxygen electrode, respectively, and each comprise a catalyst and a binder. The first and second catalyst layers 210 and 210′ may each independently further comprise a material that may increase an electrochemical surface area of the catalyst.

The first and second primary gas diffusion layers 221 and 221′ and the first and second secondary gas diffusion layers 220 and 220′, for example, may comprise carbon and may be in the form of a carbon sheet or carbon paper, respectively, and may have a porosity and surface properties suitable to diffuse oxygen and fuel, which are supplied through the bipolar plates 120 and 120′, to an entire surface of the catalyst layers 210 and 210′.

The fuel cell 100, including the membrane electrode assembly 110, may operate at a temperature of about 0° C. to about 300° C., specifically about 100° C. to about 250° C. A fuel, for example hydrogen, may be supplied to a side of the first catalyst layer 210 through the first bipolar plate 120, and an oxidizer, for example oxygen, may be supplied to a side of the second catalyst layer 210′ through the second bipolar plate 120′. Hydrogen is oxidized at a surface of the catalyst layer 210 to generate a hydrogen ion (H⁺), and the hydrogen ion (H⁺) arrives at the second catalyst layer 210′ by conducting through the electrolyte membrane 200. Then, electrical energy as well as water (H₂O) is generated by electrochemically reacting the hydrogen ion (H⁺) and oxygen at the second catalyst layer 210′. Also, the hydrogen supplied as a fuel may be hydrogen generated by reforming a hydrocarbon, such as an alcohol, and the oxygen supplied as the oxidizer may be supplied by supplying air.

Hereinafter, the present disclosure will be described in more detail with reference to examples and comparative examples. The following examples are provided to allow for a clearer understanding of the present disclosure. The scope of the present disclosure shall not be limited thereto.

### EXAMPLES

### Example 1

### Preparation of Carbonaceous Support Mixture

A carbonaceous support mixture was prepared by ultrasonically dispersing 0.1 gram (g) of a carbonaceous support KB (Ketjen black, 800 square meters per gram, m²/g) in a mixture of H₂O and isobutyl alcohol (IPA) (a weight ratio between H₂O and IPA was 67:33) for 30 minutes.

### Preparation of Metal Precursor Mixture

2.771 g of 4 weight percent (wt %) K₂PdCl₄ (a content of Pd in K₂PdCl₄ was 32.1 wt %) and 3.414 g of 4 wt % H₂IrCl₆.6H₂O (a content of Ir in H₂IrCl₆.6H₂O was 47.2 wt %) were prepared so as to obtain an atomic ratio of Pd:Ir of 1:1, and 1.902 g of 4 wt % KMnO₄ was prepared so as to obtain a weight ratio of Pd+Ir:Mn of 100:50. A metal precursor mixture was then prepared by mixing 0.854 g of a 30 wt % sodium citrate aqueous solution as a chelating agent therewith in a three-neck flask.

### Preparation of Mixture for Preparing Catalyst

The metal precursor mixture was combined with the carbonaceous support mixture to prepare a mixture for preparing a catalyst. A pH of the mixture for preparing a catalyst was then adjusted to a range of about 10 to about 12 using 1 molar (M) aqueous NaOH, and the mixture was stirred for about 30 minutes.

### Preparation of Pre-catalyst 1

The mixture for preparing a catalyst was transferred to an autoclave reactor, and Pd—Ir—MnOₓ particles (x is a real number in a range of 0<x≦2) on the carbonaceous support were reduced by increasing a reaction temperature to about 160° C. and holding the temperature for about 1 hour. A product thus obtained was filtered, washed, and dried to obtain a pre-catalyst 1, in which Pd—Ir—MnOₓ pre-particles 1 on the carbon support (x is a real number in a range of 0<x≦2, a weight ratio of Pd+Ir:Mn was 100:50) was obtained.

### Preparation of Catalyst 1 from Pre-catalyst 1

Pre-catalyst 1 was put in an alumina crucible, heated to about 300° C. in a hydrogen (H₂) atmosphere, and heat treated at about 300° C. for about 2 hours. Pre-catalyst 1 was cooled to room temperature (about 25° C.) and the MnOₓ therein was then removed from the Pre-particles 1 by stirring in 0.1 M aqueous HNO₃ at room temperature for about 2 hours. A product thus obtained was filtered, washed, and dried to obtain Catalyst 1, in which theoretically 50 wt % of Pd—Ir alloy particles (porous alloy particles having an atomic ratio of Pd:Ir of 1:1) on the carbon support were obtained.

### Example 2

### Preparation of Pre-catalyst 2

Pre-catalyst 2, in which Pd—Ir—MnOₓ Pre-particles 2 (x is a real number in a range of 0<x≦2, a weight ratio of Pd+Ir:Mn was about 100:100) on the carbonaceous support were prepared, was obtained in the same manner as the preparation method of Pre-catalyst 1 of Example 1 except that 3.803 g of KMnO₄ was used so as to obtain a weight ratio of Pd+Ir:Mn of 100:100 from the preparation of the metal precursor mixture.

### Preparation of Catalyst 2 from Pre-catalyst 2

Catalyst 2, in which theoretically 50 wt % of Pd—Ir alloy particles (porous alloy particles having an atomic ratio of Pd:Ir of 1:1) on the carbonaceous support were prepared, was obtained in the same manner as the preparation method of Catalyst 1 of Example 1 except that Pre-catalyst 2 was used instead of Pre-catalyst 1.

### Example 3

### Preparation of Pre-catalyst 3

Pre-catalyst 3, in which Pd—Ir—MnOₓ Pre-particles 3 (x is a real number in a range of 0<x≦2, a weight ratio of Pd+Ir:Mn was 100:200) on the carbonaceous support were prepared, was obtained in the same manner as the preparation method of Pre-catalyst 1 of Example 1 except that 7.607 g of KMnO₄ was used so as to obtain a weight ratio of Pd+Ir:Mn of 100:200 from the preparation of the metal precursor mixture.

### Preparation of Catalyst 3 from Pre-catalyst 3

Catalyst 3, in which theoretically 50 wt % of Pd—Ir alloy particles (porous alloy particles having an atomic ratio of Pd:Ir of 1:1) on the carbonaceous support were prepared, was obtained in the same manner as the preparation method of Catalyst 1 of Example 1 except that Pre-catalyst 3 was used instead of Pre-catalyst 1.

### Example 4

### Preparation of Pre-catalyst 4

Pre-catalyst 4, in which Pd—Ir—ZnOₓ Pre-particles 4 (x is a real number in a range of 0<x≦2, a weight ratio of Pd+Ir:Zn was 100:50) on the carbonaceous support were prepared, was obtained in the same manner as the preparation method of Pre-catalyst 1 of Example 1 except that 3.455 g of ZnNO₃.6H₂O was used so as to obtain a weight ratio of Pd+Ir:Zn of 100:50, instead of KMnO₄, from the preparation of the metal precursor mixture.

### Preparation of Catalyst 4 from Pre-catalyst 4

Catalyst 4, in which theoretically 50 wt % of Pd—Ir alloy particles (porous alloy particles having an atomic ratio of Pd:Ir of 1:1) on the carbonaceous support were prepared, was obtained in the same manner as the preparation method of Catalyst 1 of Example 1 except that Pre-catalyst 4 was used instead of Pre-catalyst 1.

### Example 5

### Preparation of Pre-catalyst 5

Pre-catalyst 5, in which Pd—Ir—ZnOₓ Pre-particles 4 (x is a real number in a range of 0<x≦2, a weight ratio of Pd+Ir:Zn was 100:100) on the carbonaceous support were prepared, was obtained in the same manner as the preparation method of Pre-catalyst 1 of Example 1 except that 6.911 g of ZnNO₃.6H₂O was used so as to obtain a weight ratio of Pd+Ir:Zn of 100:100, instead of KMnO₄, from the preparation of the metal precursor mixture.

### Preparation of Catalyst 5 from Pre-catalyst 5

Catalyst 5, in which theoretically 50 wt % of Pd—Ir alloy particles (porous alloy particles having an atomic ratio of Pd:Ir of 1:1) on the carbonaceous support were prepared, was obtained in the same manner as the preparation method of Catalyst 1 of Example 1 except that Pre-catalyst 5 was used instead of Pre-catalyst 5.

### Example 6

### Preparation of Pre-catalyst 6

Pre-catalyst 6, in which Pd—Ir—ZnOₓ Pre-particles 6 (x is a real number in a range of 0<x≦2, a weight ratio of Pd+Ir:Zn was 100:200) on the carbonaceous support were prepared, was obtained in the same manner as the preparation method of Pre-catalyst 1 of Example 1 except that 13.822 g of ZnNO₃.6H₂O was used so as to obtain a weight ratio of Pd+Ir:Zn of 100:200, instead of KMnO₄, from the preparation of the metal precursor mixture.

### Preparation of Catalyst 6 from Pre-catalyst 6

Catalyst 6, in which theoretically 50 wt % of Pd—Ir alloy particles (porous alloy particles having an atomic ratio of Pd:Ir of 1:1) on the carbonaceous support were prepared, was obtained in the same manner as the preparation method of Catalyst 1 of Example 1 except that Pre-catalyst 6 was used instead of Pre-catalyst 1.

### Comparative Example A

A mixture for preparing a catalyst was prepared in the same manner as the preparation method of the mixture for preparing a catalyst of Example 1 except that KMnO₄ was not used during the preparation of the metal precursor mixture. The mixture for preparing a catalyst was transferred to an autoclave reactor, and Pd—Ir particles on a carbonaceous support were reduced by increasing a reaction temperature to about 160° C. and holding the temperature for about 1 hour. As a result, Catalyst A, in which theoretically about 50 wt % of Pd—Ir particles (non-porous alloy particles having an atomic ratio of Pd:Ir of 1:1) on the carbonaceous support were prepared, was obtained.

### Comparative Example B

A mixture for preparing a catalyst was prepared in the same manner as the preparation method of the mixture for preparing a catalyst of Example 1 except that an amount of 4 wt % KMnO₄ was used so as to obtain a weight ratio of Pd+Ir:Mn of 100:0.025 during the preparation of the metal precursor mixture. The mixture for preparing a catalyst was transferred to an autoclave reactor to obtain Catalyst B, in which theoretically 50 wt % of Pd—Ir—MnOₓ particles (non-porous alloy particles in which x is a real number in a range of 0<x≦2, a weight ratio of Pd:Ir is 1:1 and 2.5 wt % of MnOₓ are included) on the carbon support were prepared, by increasing a reaction temperature to about 160° C. and holding the temperature for about 1 hour.

### Comparative Example C

A mixture for preparing a catalyst was prepared in the same manner as the preparation method of the mixture for preparing a catalyst of Example 1 except that an amount of ZnNO₃.6H₂O was used so as to obtain a weight ratio of Pd+Ir:Zn of 100:0.025 during the preparation of the metal precursor mixture. The mixture for preparing a catalyst was transferred to an autoclave reactor to obtain Catalyst C, in which theoretically 50 wt % of Pd—Ir—ZnOₓ particles (non-porous alloy particles in which x is a real number in a range of 0<x≦2, a weight ratio of Pd:Ir is 1:1 and 2.5 wt % of ZnOₓ are included) on the carbon support were prepared, by increasing a reaction temperature to about 160° C. and holding the temperature for about 1 hour.

TABLE 1

| | | | Weight ratio of | Type of alloy |
|---|---|---|---|---|
| | | Pre-particles | Pd + Ir:Mn | particles of |
| | Catalyst | of pre-catalyst | in pre-particles | catalyst |
| Example 1 | Catalyst | Pd—Ir—MnOₓ | 100:50 | Porous |
| | 1 | pre-particles 1 | | |
| | | (0 < x ≦ 2) | | |
| Example 2 | Catalyst | Pd—Ir—MnOₓ | 100:100 | Porous |
| | 2 | pre-particles 2 | | |
| | | (0 < x ≦ 2) | | |
| Example 3 | Catalyst | Pd—Ir—MnOₓ | 100:200 | Porous |
| | 3 | pre-particles 3 | | |
| | | (0 < x ≦ 2) | | |
| Example 4 | Catalyst | Pd—Ir—ZnOₓ | 100:50 | Porous |
| | 4 | pre-particles 4 | | |
| | | (0 < x ≦ 2) | | |
| Example 5 | Catalyst | Pd—Ir—ZnOₓ | 100:100 | Porous |
| | 5 | pre-particles 5 | | |
| | | (0 < x ≦ 2) | | |
| Example 6 | Catalyst | Pd—Ir—ZnOₓ | 100:200 | Porous |
| | 6 | pre-particles 6 | | |
| | | (0 < x ≦ 2) | | |
| Comparative | Catalyst | — | — | Non-porous |
| Example A | A | | | |
| Comparative | Catalyst | — | — | Non-porous |
| Example B | B | | | |
| Comparative | Catalyst | — | — | Non-porous |
| Example C | C | | | |

### Evaluation Example 1

### Transmission Electron Microscope (TEM) Analysis

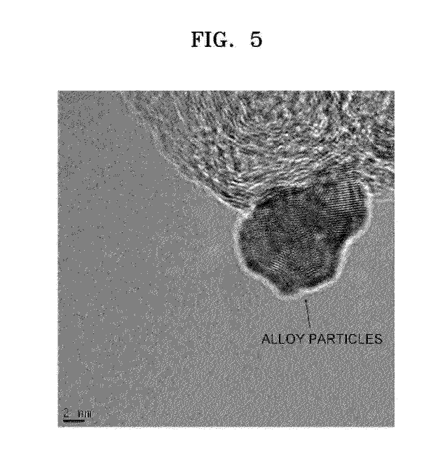

Catalyst 2 (Example 2) was analyzed by transmission electron microscopy and the results are shown in FIG. 5. The TEM analysis confirms that the alloy particle in FIG. 5 includes a plurality of pores, which appear as white circles.

### Evaluation Example 2

### X-Ray Diffraction (XRD) Analysis

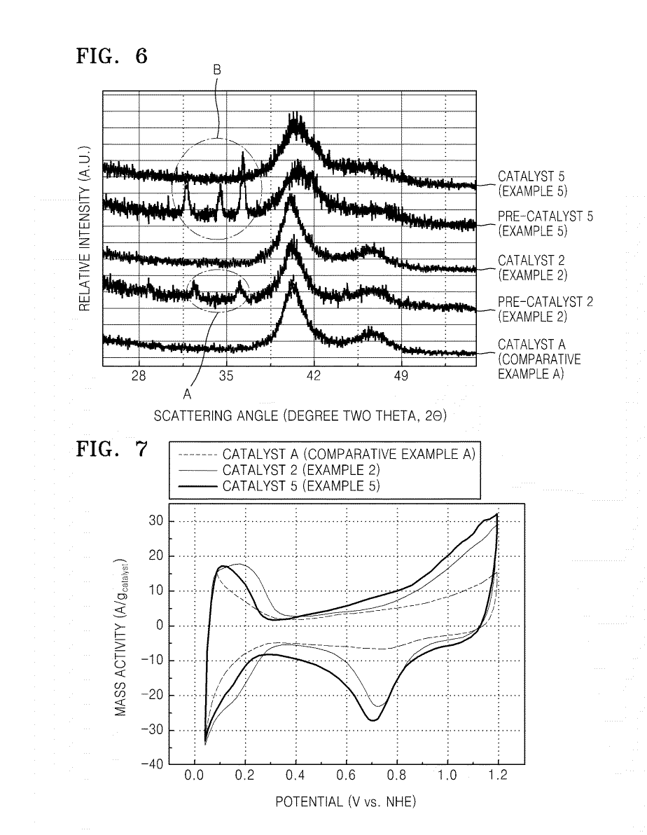

X-ray diffraction analyses (MP-XRD, X-pert PRO, Philips/power 3 Kw) were performed on Catalyst A (Comparative Example A), Catalyst B (Comparative Example B), Catalyst C (Comparative Example C), Pre-catalyst 2 (Example 2), Catalyst 2 (Example 2), Pre-catalyst 5 (Example 5), and Catalyst 5 (Example 5) and the results thereof are presented in FIG. 6 and the following Table 2.

TABLE 2

| | | Average particle | |
|---|---|---|---|
| | | diameter (nm) of | |
| | | particles (or pre- | Diffraction angle |
| | | particles) included | (2 theta) of (111) |
| | Catalyst | in catalyst | peak in XRD data |
| Comparative A | Catalyst A | 4.834 | 40.4044 |
| Comparative B | Catalyst B | 4.613 | 40.4340 |
| Comparative C | Catalyst C | 3.835 | 40.5911 |
| Example 2 | Pre-catalyst 2 | 4.47 | 40.4197 |
| | Catalyst 2 | 3.40 | 40.4340 |
| Example 5 | Pre-catalyst 5 | 3.001 | 40.6001 |
| | Catalyst 5 | 2.810 | 40.5994 |

As shown in FIG. 6 and Table 2, the XRD data shows that Catalyst A, Pre-catalyst 2, and Catalyst 2 included Pd—Ir alloys because Catalyst A, Catalyst B, Catalyst C, Pre-catalyst 2, Catalyst 2, Pre-catalyst 5 and Catalyst 5 had (111) peaks at diffraction angles of about 40.4 degrees.

The XRD data of Pre-catalyst 2 in FIG. 6 included peaks due to MnOₓ (see “A” peaks included in an ellipse in FIG. 6), but the XRD data of Catalyst 2 did not include peaks due to MnOₓ. These results show that the pores of the porous alloy particles of Catalyst 2 prepared by removing MnOₓ from the Pre-particles 2 of Pre-catalyst 2 correspond to MnOₓ regions of the Pre-particles 2 of Pre-catalyst 2.

The XRD data of Pre-catalyst 5 in FIG. 6 included peaks due to ZnOₓ (see “B” peaks included in an ellipse in FIG. 6), but the XRD data of Catalyst 5 did not include peaks due to ZnOₓ. These results show that the pores of the porous alloy particles of Catalyst 5 prepared by removing ZnOₓ from the Pre-particles 5 of Pre-catalyst 5 correspond to ZnOₓ regions of the Pre-particles 5 of Pre-catalyst 5.

### Evaluation Example 3

### Inductively Coupled Plasma (ICP) Analysis

ICP analyses (ICP-AES, ICPS-8100, SHIMADZU/RF source of about 27.12 megahertz (MHz)/sample uptake rate of about 0.8 milliliters per minute (mL/min)) were performed on Catalyst A (Comparative Example A), Catalyst 1 (Example 1), Pre-catalyst 2 (Example 2), Catalyst 2 (Example 2), Pre-Catalyst 3 (Example 3), Catalyst 3 (Example 3), Pre-Catalyst 5 (Example 5) and Catalyst 5 (Example 5), respectively. The results thereof are presented in Table 3.

TABLE 3

| | | ICP analysis results (wt %) | | | |
|---|---|---|---|---|---|
| | Catalyst | Pd | Ir | Mn | Zn |
| Comparative A | Catalyst A | 19.84 | 30.05 | 0 | 0 |
| Example 1 | Catalyst 1 | 21.2 | 30.4 | 0.2 | 0 |
| Example 2 | Pre-catalyst 2 | 21.9 | 31.5 | 9.2 | 0 |
| | Catalyst 2 | 21.9 | 31.5 | 0.14 | 0 |
| Example 3 | Pre-catalyst 3 | 15.2 | 23 | 24.6 | 0 |
| | Catalyst 3 | 30.2 | 15.7 | 0.41 | 0 |
| Example 5 | Pre-catalyst 5 | 19.70 | 34.05 | 0 | 10.25 |
| | Catalyst 5 | 19.70 | 34.05 | 0 | 3.25 |

As shown in Table 3, Catalysts 2 and 3 prepared by removing MnOₓ from Pre-particles 2 and 3 of Pre-catalysts 2 and 3 contained much less Mn in comparison to Pre-catalysts 2 and 3, respectively. However, it may be confirmed that Catalysts 2 and 3 included a small amount of unremoved Mn, i.e., 0.14 wt % in Catalyst 2 and 0.41 wt % in Catalyst 3. Furthermore, Catalyst 5 prepared by removing ZnOₓ from Pre-particles 5 of Pre-catalysts 5 contained much less Zn in comparison to Pre-catalysts 5, respectively. However, it may be confirmed that Catalyst 5 included a small amount of unremoved Zn.

### Evaluation Example 4

### Cyclic Voltammetry, Hydrogen Desorption Charge, and Oxygen Reduction Reaction Analysis

Electrodes were prepared below by respectively using Catalysts 2, 5, and A prepared in Examples 2 and 5, and Comparative Example A, and cyclic voltammograms and hydrogen desorption charges thereof were evaluated.

About 0.02 g of Catalyst 2 was dispersed in about 10 g of ethylene glycol and about 15 microliters (μL) of the dispersed solution was dispensed into a glassy carbon rotating electrode using a micropipette, and vacuum drying was performed at about 80° C. About 15 μL of about 5 wt % of a Nafion solution dispersed in ethylene glycol was then dispensed into the electrode, in which the catalyst had been dispensed, and a working electrode was prepared by drying, performed in the same manner as above.

The working electrode thus prepared was installed on a rotating disk electrode (RDE) apparatus, and a platinum wire and Ag/AgCl (KClₛₐₜ) were prepared as a counter electrode and a reference electrode, respectively. The prepared three-phase electrode was put in a 0.1 M HClO₄ electrolyte solution and residual oxygen in the solution was removed by nitrogen bubbling for about 30 minutes. Current density values were measured by performing cyclic voltammetry in a range of about 0.03 V to about 1.2 V (vs. normal hydrogen electrode (NHE)) using a potentiostat/galvanostat and mass activities of Catalyst 1 were evaluated by measuring the mass activities (Amperes per gram, Ng) in which the current density values were divided by a weight of Catalyst 2. The foregoing procedure was repeated with respect on Catalysts 5 and A, and the results thereof are presented in FIG. 7.

A hydrogen desorption charge (Q_{H}) with respect to catalyst particles of each catalyst was evaluated by determining an area obtained by multiplying a current value and a voltage value within a range of about 0 V to about 0.4 V (vs. NHE) in a cyclic voltammogram of each catalyst, and the results thereof are presented in the following Table 4. The hydrogen desorption charge is an amount of hydrogen ions adsorbed with respect to catalyst particles in a catalyst and is a basis of calculating an electrochemical specific surface area of respective catalyst particles. An electrochemical specific surface area (in m²/g) of catalyst particles of each catalyst was calculated by dividing hydrogen desorption charges (Q_{H}) of Catalysts A, 2, and 5 by 0.21 mC/cm² and a weight of respective catalyst particles of each catalyst, and the results thereof are presented in Table 4. Herein, 0.21 mC/cm² is an intrinsic constant with respect to a quantity of electric charge when hydrogen is adsorbed as a single molecular layer on a surface of a catalyst particle.

TABLE 4

| | | | Electrochemical |
|---|---|---|---|
| | | | specific surface |
| | | Q_{H} (mC/cm²) ¹ | area (m²/g) ² |
| Comparative Example 1 | Catalyst A | 31 × 10⁻³ | 49.2 |
| Example 2 | Catalyst 2 | 60 × 10⁻³ | 95.2 |
| Example 5 | Catalyst 5 | 45 × 10⁻³ | 71.4 |

In Table 4:
¹ a hydrogen desorption charge per catalyst particle surface area (cm²) of each catalyst; and
² a specific surface area per catalyst particle weight (g) of each catalyst.

As shown in FIG. 7 and Table 4, the hydrogen desorption charges and electrochemical specific surface areas of Catalysts 2 and 5 were better than those of Catalyst A.

Also, it is shown that ΔQ_{H} of Catalyst 2 was about 193% (60/31×100) and ΔQ_{H} of Catalyst 5 was about 145% (45/31×100).

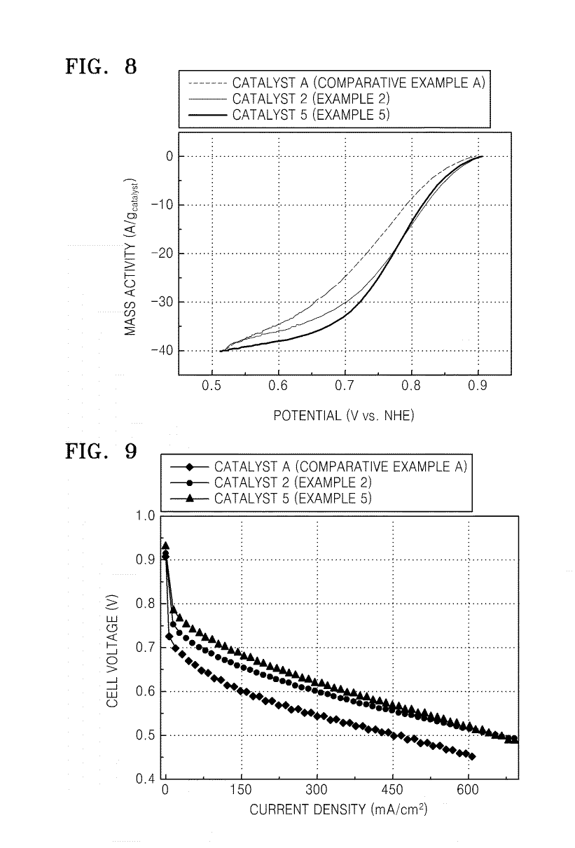

Next, oxygen was dissolved and saturated in the electrolyte solution, and oxygen reduction reaction (ORR) currents were then recorded in a negative direction from open circuit voltages (OCV) to potentials of about 0.4 V to about 0.6 V vs. NHE, generating a material limiting current while the glassy carbon rotating electrode was rotated and are shown in FIG. 8. Mass activities at 0.75 V were evaluated as described above and the results thereof are presented in the following Table 5.

TABLE 5

| | | Mass activity at 0.75 V |
|---|---|---|
| | | (A/g_{catalyst}) |
| Comparative Example 1 | Catalyst A | −11.3 |
| Example 2 | Catalyst 2 | −23.45 |
| Example 5 | Catalyst 5 | −25.88 |

As shown in FIG. 8 and Table 5, it may be confirmed that ORRs of Catalysts 2 and 5 were better than that of Catalyst A.

### Evaluation Example 5

### Performance Evaluation of Unit Cell

### Preparation of Unit Cell

A slurry for a cathode was prepared by mixing 0.03 g of polyvinylidene fluoride (PVDF) and 1 g of Catalyst A (Comparative Example A) with an appropriate amount of a solvent N-methylpyrrolidone (NMP) to form a slurry. A carbon paper coated with a microporous layer was coated with the slurry for a cathode using a bar coater and a cathode was then prepared using a drying process in which a temperature was increased stepwise from room temperature to about 150° C. A loading amount of Catalyst A in the cathode was about 1.5 mg/cm².

An anode was prepared using a PtRu/C catalyst and a loading amount of the PtRu/C catalyst in the anode was about 0.8 mg/cm².

As an electrolyte membrane between the cathode and the anode, Membrane electrode assembly A was prepared using t-PBOA doped with about 85 wt % of phosphoric acid.

Membrane electrode assembly 2 was prepared in a manner similar to Membrane Electrode Assembly A except that Catalyst 2 of Example 2 and Catalyst 5 of Example 5, respectively, was used instead of using Catalyst A.

### Unit Cell Test

The performance of Membrane electrode assemblies A, 2 and 5 were evaluated at about 150° C. using non-humidified air at about 250 cubic centimeters per minute (cc/min) at the cathode and non-humidified hydrogen at about 100 cc/min at the anode, and the results thereof are presented in FIG. 9 and Table 6.

TABLE 6

| | | Electric |
|---|---|---|
| | Catalyst included in | potential (V) |
| | the cathode | at 0.2 A/cm² |
| Membrane electrode assembly A | Catalyst A (Comparative | 0.58 |
| | Example A) | |
| Membrane electrode assembly 2 | Catalyst 2 (Example 2) | 0.64 |
| Membrane electrode assembly 5 | Catalyst 5 (Example 5) | 0.66 |

As shown in FIG. 9 and Table 6, Membrane electrode assembly 2 and Membrane electrode assembly 5 had a higher electric potential at 0.2 A/cm² than the electric potential at 0.2 A/cm² of Membrane electrode assembly A.

The electrode catalyst for a fuel cell disclosed herein provides excellent electrochemical specific surface area and oxygen-reduction activity, and thus can be used to provide a lower cost and higher performance fuel cell.

While the disclosed embodiments have been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrode catalyst for a fuel cell, the electrode catalyst comprising:
porous catalyst particles comprising a noble metal having oxygen-reduction activity; and
a carbonaceous support,
wherein the porous catalyst particles are disposed on the carbonaceous support, and an electrochemical specific surface area of the porous catalyst particles is about 70 m²/g or more.

2. The electrode catalyst for a fuel cell of claim 1, wherein the electrochemical specific surface area of the porous catalyst particles is about 80 m²/g to about 100 m²/g.

3. The electrode catalyst for a fuel cell of claim 1, wherein the porous catalyst particles comprise pores and a skeleton including the noble metal.

4. The electrode catalyst for a fuel cell of claim 1, wherein the porous catalyst particles comprise a pore defined entirely by the noble metal.

5. The electrode catalyst for a fuel cell of claim 1, wherein the noble metal comprises one or more selected from palladium (Pd), iridium (Ir), gold (Au), platinum (Pt), rhenium (Re), osmium (Os), ruthenium (Ru), rhodium (Rh), and silver (Ag).

6. The electrode catalyst for a fuel cell of claim 1, wherein the porous catalyst particles comprise a composition represented by Formula 1:
Pd_{1-y}Ir_{y} Formula 1
wherein y denotes an atomic ratio of Ir to Pd and 0<y<1.

7. The electrode catalyst for a fuel cell of claim 1, wherein the porous catalyst particles further comprise a transition metal including one or more selected from titanium (Ti), vanadium (V), chromium (Cr), manganese (Mn), iron (Fe), cobalt (Co), nickel (Ni), copper (Cu), and zinc (Zn).

8. The electrode catalyst for a fuel cell of claim 1, wherein the porous catalyst particles further comprise a metal oxide.

9. The electrode catalyst for a fuel cell of claim 8, wherein the metal oxide is an acid soluble oxide of a metal of Groups 7 to 12 of the periodic table of the elements.

10. The electrode catalyst for a fuel cell of claim 8, wherein the metal oxide comprises one or more selected from manganese oxide, iron oxide, cobalt oxide, nickel oxide, and zinc oxide.

11. The electrode catalyst for a fuel cell of claim 8, wherein a content of the metal oxide is about 0.6 parts by weight or less, based on 100 parts by weight of the electrode catalyst.

12. The electrode catalyst for a fuel cell of claim 11, wherein the carbonaceous support comprises an ordered mesoporous carbon having mesopores.

13. The electrode catalyst for a fuel cell of claim 1, wherein the porous catalyst particles further comprise a product of heating and acid treatment of a metal oxide.

14. The electrode catalyst for a fuel cell of claim 1, wherein a hydrogen desorption charge of the porous catalyst particles is about 40×10⁻³ mC/cm² to about 80×10⁻³ mC/cm².

15. A method of preparing an electrode catalyst for a fuel cell, the method comprising:
providing a pre-catalyst comprising
a carbonaceous support, and
pre-particles disposed on the carbonaceous support, the pre-particles comprising
a noble metal having oxygen-reduction activity,
a metal oxide; and
removing the metal oxide from the pre-particles to prepare the electrode catalyst of claim 1.

16. The method of claim 15, wherein the metal oxide comprises one or more selected from manganese oxide, iron oxide, cobalt oxide, nickel oxide, and zinc oxide.

17. The method of claim 15, wherein pores of the porous catalyst particles correspond to regions of the metal oxide in the pre-particles.

18. The method of claim 15, wherein the removing of the metal oxide from the pre-particles comprises contacting the pre-catalyst with an acid.

19. The method of claim 18, wherein the acid comprises one or more selected from HNO₃, HClO₃, HBrO₃, HCl, H₂SO₄, H₃PO₄, and CH₃COOH.

20. The method of claim 15, wherein a change in an electrochemical specific surface area of the electrode catalyst is greater than about 100% and equal to or less than about 500%, wherein the change in the electrochemical specific surface area is determined by a change in a hydrogen desorption charge ΔQ_{H} in Equation 1:
ΔQ_{H}(%)=Q_{H}(porous)/Q_{H}(non-porous)×100 Equation 1
wherein Q_{H} (porous) denotes a hydrogen desorption charge of the catalyst; and Q_{H} (non-porous) denotes a hydrogen desorption charge of a catalyst including non-porous catalyst particles including a same noble metal as a noble metal of the porous catalyst particles of the electrode catalyst.

21. A membrane electrode assembly for a fuel cell comprising:
a cathode;
an anode disposed facing the cathode; and
an electrolyte membrane disposed between the cathode and the anode,
wherein one or more of the cathode and the anode comprises the electrode catalyst of claim 1.

22. The membrane electrode assembly for a fuel cell of claim 21, wherein the cathode comprises the catalyst.

23. A fuel cell comprising the membrane electrode assembly of claim 21.

24. The fuel cell of claim 23, wherein the cathode comprises the catalyst.
